(19) United States
(12) Patent Application Publication
(10) Pub. No.: US 2011/0179160 A1
(43) Pub. Date: Jul. 21, 2011

(54) Activity Graph for Parallel Programs in Distributed System Environment

(75) Inventors: Guowei Liu, Beijing (CN); Zhitao Hou, Beijing (CN); Haidong Zhang, Beijing (CN)

(73) Assignee: Microsoft Corporation, Redmond, WA (US)

(21) Appl. No.: 12/691,312

(22) Filed: Jan. 21, 2010

(51) Int. Cl. G06F 15/16

(52) U.S. Cl. 709/224

(57) ABSTRACT

In a distributed system environment, a system profiling log can be used at a central server to collect and analyze log data. The log data can be used to gauge performance of software applications. In particular, the log data includes different activities (i.e., tasks) that are executed to implement the software applications. Correlation of the different activities versus a timeline is an important parameter in the system profiling log. For example, where the correlation of the different activities is represented in colored graphs at a user interface, a user may easily pinpoint a bottleneck. The bottleneck at the one or more activities may encourage the user to adopt system improvement in the distributed system environment.

### BACKGROUND

A primary reason for writing programs, such as, writing parallel programs is speed. Once the parallel program has been written and errors have been eliminated, programmers generally turn their attention to performance of the parallel program. Most application programmers gauge the performance of their program (i.e., serial or parallel programs) by turnaround time. The turnaround time can provide insights to the application programmers on why the programs do not run fast enough. In a distributed system environment, the turnaround time provides a more important parameter to gauge the performance of the programs.

In an implementation, an increase in numbers and/or computational power of processors in the distributed system environment provides complexity of performance data that must be gathered to provide the turnaround time. This wealth of information is a problem for the application programmers who are forced to navigate through the performance data that are or will be executed in the distributed system environment. In other implementations, additional data from other functions, applications, and the like supplies additional information for the application programmer to navigate. To this end, methods and procedures are implemented to allow a user or the application programmer to obtain speedy visualization of the performance data in the distributed system environment.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed description that is presented later.

In an implementation, a testing environment with different configurations is set up to visualize a system profiling log. The different configurations may include at least one or more process in one or more machines; one or more components (i.e., software applications) in the one or more processes; and one or more activities (i.e., tasks) in the one or more components. In an implementation, the one or more activities are represented in a colored graph by the system profiling log to a user interface. The colored graph includes the one or more activities (in the one or more components) versus a timeline. To this end, a user of the system profiling log may determine a system behavior and pinpoint a bottleneck on the one or more activities that are or will be executed at the one or more machines.

To the accomplishment of the foregoing and related ends, certain illustrative aspects are described herein in connection with the following description and the annexed drawings. These aspects are indicative of various ways in which the disclosed subject matter can be practiced, all of which are intended to be within the scope of the disclosed subject matter. Other advantages and novel features can become apparent from the following detailed description when considered in conjunction with the drawings.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a block diagram of an exemplary distributed system environment.

FIG. 2 is an exemplary implementation of a computing device or a computer in the distributed system environment.

FIG. 3 is an exemplary illustration of an agent in the computing device.

FIG. 4 is an exemplary illustration of a user interface showing colored graphical activities versus a timeline.

FIG. 5 is a flow chart for visualizing a colored activity graphs in the distributed system environment.

### DETAILED DESCRIPTION

### Overview

In a distributed system environment, a system profiling log can be used at a central server to collect and analyze log data. The collection and analysis of the log data can be used to gauge performance of software applications. In an implementation, the log data includes different activities (i.e., tasks)—from one or more components (i.e., software applications)—that are executed in at least one or more computers in the distributed system environment. Correlation and/or collaboration of the different activities versus a timeline are an important parameter in the system profiling log. For example, where the correlation and/or the collaboration of the different activities are represented in colored graphs at a user interface, a user may easily pinpoint a bottleneck. The bottleneck at the one or more activities may encourage the user to adopt system improvements in the distributed system environment.

### Architecture Implementations

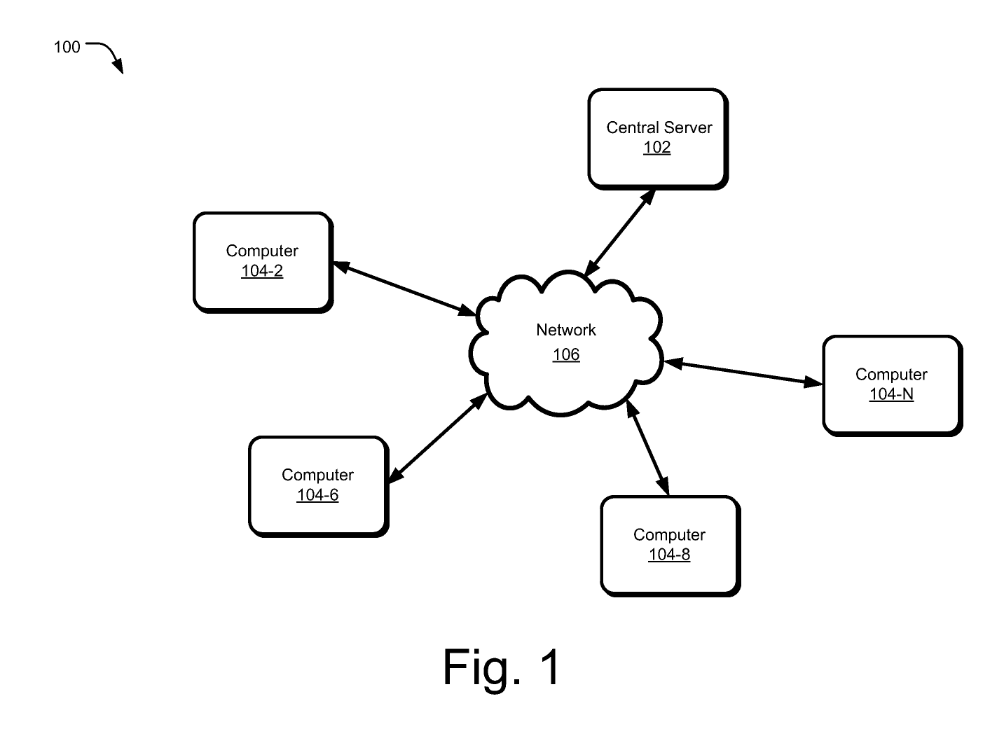

FIG. 1 illustrates a system-level overview of an exemplary distributed system environment 100. The distributed system environment 100 may include, at a minimum, a data processing system that utilizes more than one software application simultaneously; or the data processing system includes at least two or more processors. For example, a single computer that is running two or more software applications simultaneously, such as, a data base application and a spreadsheet application, fulfills the definition of the distributed system environment 100. Likewise, two or more computers (or processors), often hundreds or even millions (in the case of Internet) satisfy the definition of the distributed system environment 100.

The distributed system environment 100 may include a computing device or central server 102, computing devices or computers 104-2, 104-4, . . . 104-N (hereinafter referred to as computers 104 where N is an integer), and a network 106. In an implementation, the central server 102 is a control and display station that includes computer hardware and software. The control and display station is not limited to the central server 102; however, each computers 104-2, 104-4, . . . 104-N in the distributed system environment 100 may act as the central server 102. Following a master-slave relationship, such as, when a particular computer acts as a master (e.g., central server 102), the rest of the computers (i.e., computers 104) in the distributed system environment 100 may act as slaves. The computers 104 and the central server 102 in the distributed system environment 100 can be a hand-held device, network personal computers (PC's), minicomputers, mainframe computers, and the like. In other implementations, the central server 102 can be one of the slaves that are connected to a node or another central server that acts as a main control and display station (e.g., main master).

In an implementation, the central server 102 acts as the control and display station by initially setting up a testing environment in the distributed system environment 100. The testing environment coordinates functions of the computers 104 with regard to execution of a system profiling log. The system profiling log may include a software application configured to monitor, collect, analyze, and convert log data into colored graphical representations that illustrate different tasks or activities over a time period. The system profiling log further includes different configurations for visualization of the colored graphical representations. For example, the different configurations may include selecting a particular node or particular computers 104 to provide the log data to the central server 102. The particular node or the particular computers 104 may include the log data that contains one or more activities or tasks (not shown) in one or components (i.e., software applications). To this end, the different configurations may include portion(s) or whole component of the distributed system environment 100.

In an implementation, the system profiling log includes log data collection and analysis, which provides a history diagram to visualize behavior of a particular software application. The history diagram may include real-time analysis of the particular software application that is executed at the computers 104. The history diagram may further include previously stored log data collections from the particular software application that is executed at the computers 104. In other implementations, remote log data collection is implemented from the central server 102 to analyze and convert the history diagram of the particular software application.

For the real-time analysis, a log data analyzer or agent (not shown) retrieves, collects, correlates, and analyzes log data records during the execution of the particular software application. The agent (not shown) may store the log data records into a storage unit. To this end, different tasks or activities, functions and the like, at the computers 104 are analyzed and identified at the central server 102. In addition, the central server 102 may convert the log data records into colored graph representations for visualization at a user interface. As further discussed below, a user can display details of different activities or tasks of the software application by using a zoom-in/zoom-out in the user interface. The zoom-in and zoom-out features a method of showing particular details in a particular colored graph.

The computers 104 can be elements of the node where the system profiling log is executed. To provide the log data (e.g., performance data) to the central server 102, the computers 104 are configured to collect details of the log data, such as, timeline of activity executions, number of processes, number of components or software applications in the processes, and the like. In an implementation, when the software profiling log is initiated by the user, the software profiling log may include queries on a particular activity or task performance during the execution of the software application. The computers 104 may receive and implement instructions from the central server 102 to provide the queries (e.g., timeline for all activities) needed by the user. In other implementations, the queries include details of a particular activity or tasks, such as, data load query, summation of similar tasks for a given time, and the like.

After collecting the log data by the computers 104, the central server 102 may retrieve the log data through the network 106 from the computers 104. Communication connections through the network 106 may be implemented through wire communications, wireless communications, or other suitable links. In an implementation, the log data can be used to analyze performance of a particular data processing system, and particular software application, whether under development, undergoing testing, or in full utilization. The central server 102 analyzes and converts the activities to colored graphs to gain insights on the turnaround time of the components or software applications that are executed in the distributed system environment 100.

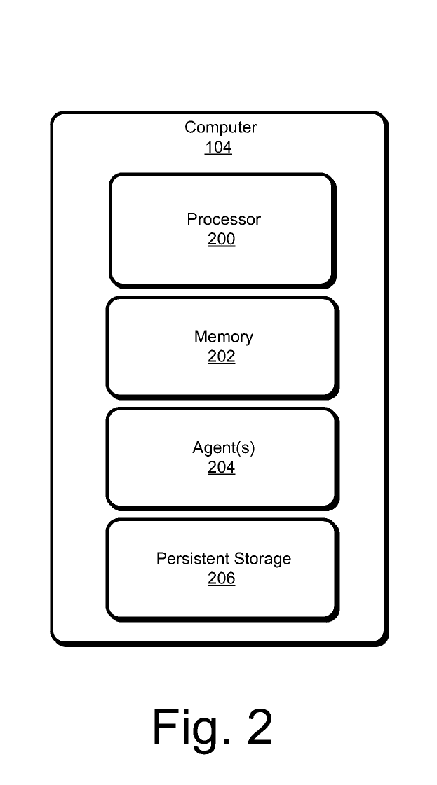

FIG. 2 illustrates an exemplary computer 104 in the distributed system environment 100. The computer 104 can include a processor component 200, a memory component 202, and one or more agents 204 (hereinafter referred to as agent 204). In an implementation, the processor component 200 may act as a central processing unit for the computer 104. Instructions from the system profiling log may be received and executed at the processor component 200. When the processor component 200 acts as a slave, the processor component 200 is configured to execute instructions received from a master, such as, the central server 102. In other implementations, the processor component 200 may include one or more processors (not shown) to run one or more components (i.e., software applications) that perform one or more tasks or activities. Furthermore, a persistent storage 206 may be included as a component of computer 104. In certain implementations, the persistent storage 206 may be an external device connected to computer 104.

The memory component 202 may be coupled to the processor component 200 to support and/or implement the execution of programs, such as, the system profiling log. The memory component 202 includes removable/non-removable and volatile/non-volatile device storage media with computer-readable instructions, which are not limited to magnetic tape cassettes, flash memory cards, digital versatile disks, and the like. The memory 202 can store processes that perform the methods that are described herein.

Agent(s) 204 monitor and collect the log data. The log data is stored in the persistent storage device 206. In an implementation, the persistent storage device 206 provides real-time log data that contains details of at least one or more activities during the execution of the software applications in the processor 200.

The agent 204 may be configured to profile one or more activities or tasks during the execution of the software applications or programs. The agent 204 may determine how each task or activity is running and how the activity collaborates with the other activities in the computer 104. In an implementation, the profiling (or execution of the system log profile) is needed when a number of parallel programs are running at the same time in the computer 104. The parallel programs may be executed in the one or more processors in the processor 200. The parallel programs may further include one or more activities that are related or collaborate with one another. In the distributed system environment 100, the profiling is implemented by the agent 204 according to instructions received from the central server 102. In other implementations, the log data collected by the agent 204 is integrated with the log data collected by the other agents in the computers 104 to provide visualization of the parallel programs that are executed in the distributed system environment 100.

In an implementation, the user in the distributed network computer 100 initiates the system profiling log at the central server 102 to visualize in colored graphs the one or more activities or tasks in the computer 104. The one or more activities or tasks may be particularly requested for visualization by the user at the central server 102. In other implementations, the user requests the one or more activities that are executed in real-time in the distributed system environment 100. To this end, the agent 204 identifies, monitors, and collects the particular log data as requested by the user.

When the log data collected by the agent 204 is communicated to the central server 102, an efficient batching mechanism may be used to reduce network traffic. In other words, transmission or communication of the log data by the agent 204 is scheduled for low-system load times. For example, collections of the log data by the agent 204 may not be sent more than some fixed period of time, e.g., every one-half to one second. In an implementation, if a number of the log data to be sent exceeds a buffering capacity in the computer 104, the number of log data is sent in real-time depending upon a setting of the system profiling log made by the user at the central server 102.

In other implementations, communications between the central server 102 and the computers 104 is synchronized when the log data is measured continuously; or the log data is recorded at regularly scheduled intervals. For example, in a continuously varying data—defined by a particular activity—that is to be represented in a colored graph, one or more agents (e.g., agent 204) are synchronized in the collection and transmission of the continuously varying data to the central server 102. The central server 102, as discussed above, integrates the continuously varying data defined by the particular activity for visualization in the user interface. In other implementations, the parallel programs in the distributed system environment 100 are visualized to determine the behavior of running activities versus a timeline. In this case, the agent 204 collects timestamps for different activities that are running in the computer 104 and sends the timestamps to the central server 102. The timestamps are converted into colored graphical representations, and the user can get an overview of the different activities that are spending more time than desired. In addition, the user may interact with the user interface zoom-in/zoom-out to drill down to more detailed information. The user can hover on the colored graphical representations for each activity bar that the user is interested in and visualize details of the activity bar, such as; begin time, end time, activity name, process information running in the activity, and the like.

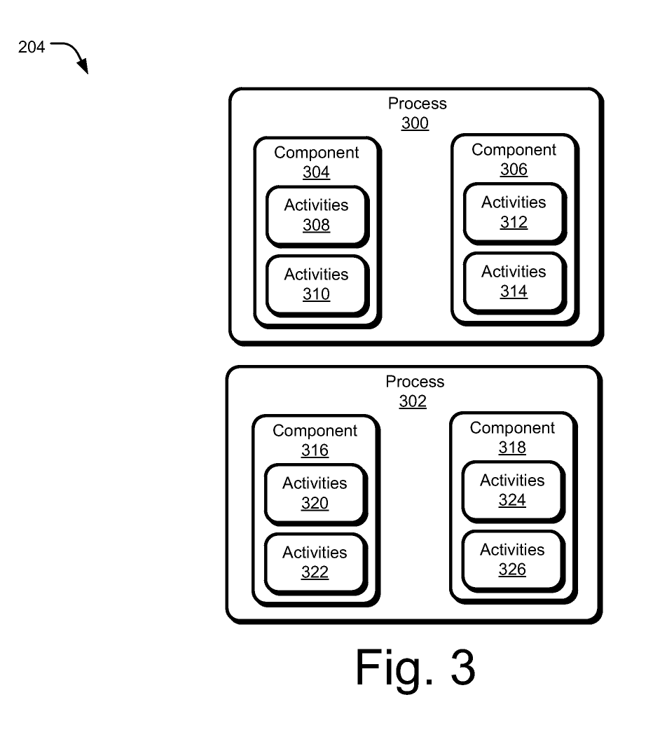

FIG. 3 is an exemplary agent 204 that collects the log data in the distributed system environment 100. In an implementation, the log data collected by the agent 204 may reside in any part or location of the computers 104; however, for illustration purposes, the log data to be collected resides within the agent 204 as shown in FIG. 3.

In an implementation, the agent 204 collects the log data that includes different configurations. The different configurations, as discussed above, includes the one or more process in the computers 104; the one or more components (i.e., software applications) in the one or more process; and the one or more activities (i.e., tasks) in the one or more components. In other implementations, the different configurations include number of nodes used; which may include computers 104 in the distributed system environment 100.

In an implementation, the agent 204 may monitor, collect and analyze log data from a process 300 and a process 302. The process 300 may include or process one type of software application; and the process 302 may include or process another type of software application. In other implementations, multiple process 300 or multiple process 302 include multiple software applications that are bundled together. The multiple software applications may include related functions, features, tasks, and may be able to interact or correlate with one another. For similar tasks that may be executed in the process 300 or the process 302, the tasks are monitored and collected as log data by the agent 204. These tasks may be integrated at the central server 102.

The process 300 may also include at least a component 304 and another component 306. The components 304 and 306 may include different software applications that are executed in the process 300. Similarly, for the component 304, several tasks or activities, such as, activities 308 and 310 are executed and/or performed to implement the software application (i.e., component 304). For example, the activity 308 may be a LOAD DATA activity; and the activity 310 may be a SEND DATA activity. The LOAD DATA may include the total load queries that are being processed in a particular computer (e.g., computer 104-2). At the central server 102, the LOAD DATA activity in the computers 104 may be integrated and converted into colored graphs. In other implementations, the component 304 is not limited to the activities 308 and 310; however, for purposes of illustration, the activities 308 and 310 are shown. The activities 308 and 310 and other activities in the component 204 are correlated during integration at the central server 102.

For the component 306, the software application may include an activity 312 and another activity 314, which include tasks that are executed to implement the component 306. In the process 302, the functions and properties described in the process 300 are similarly applied. In particular, the process 302 includes components 316 and 318. For the component 316, activities 320 and 322 are executed and/or performed; and for the component 318, activities 324 and 326 are also executed and/or performed.

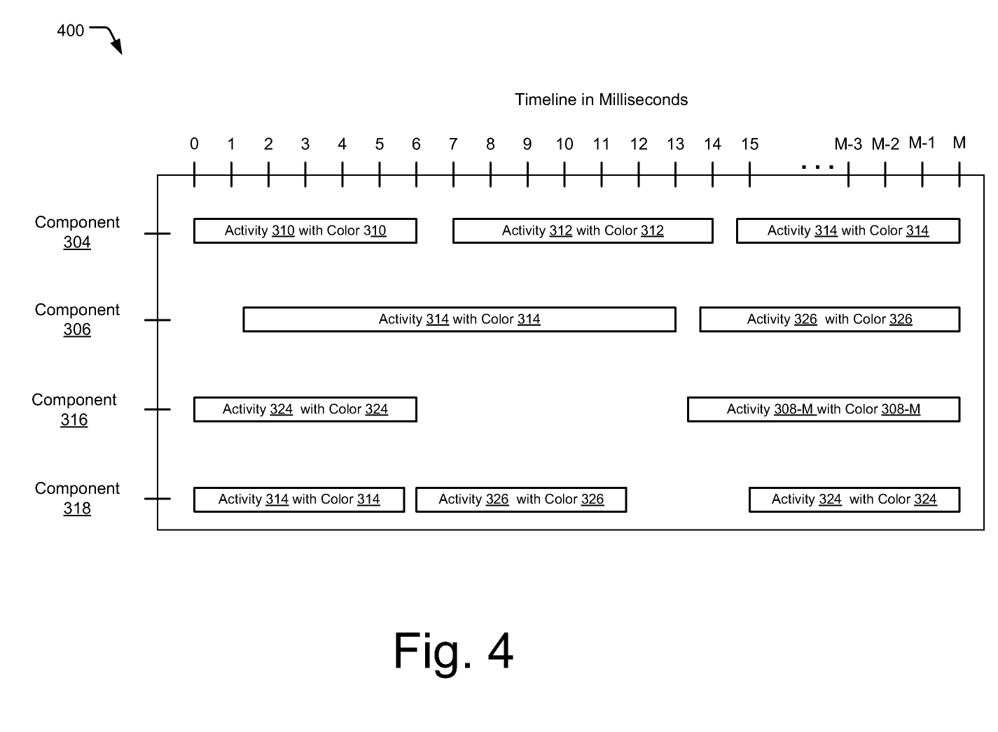

FIG. 4 illustrates a user interface showing colored graph 400 for integrated activities in the distributed system environment 100. The activities (i.e., activities 312, 314, etc.), which are integrated at the central server 102, may include different tasks that are executed to implement the components 304, 306, etc. over a timeline (where the timeline is represented in M milliseconds). In an implementation, the component 304 performs an activity 310 for time duration of 0 to 6 milliseconds. The activity 310 can be represented by a color 310 at the user interface in the central server 102. The color 310 may be visualized in color red or any other color; however, different activities (i.e., activities 312,314, etc.) should be represented or visualized by different colors. For example, activity 312 is represented by a color 312 (e.g., green) while the activity 314 is represented by a color 314 (e.g., white).

At the central server 102, the activities 310, 312, etc. are visualized or illustrated in different colors in order for the user to easily view the software profiling log. In other words, the user may determine right away which activity (e.g., activity 310) has taken a relatively longer time, such as, when the activity has exceeded a computational limit to be implemented by the activity 310. In other implementations, the activities 312,314, etc. display real-time log data that are collected and communicated by the computers 104.

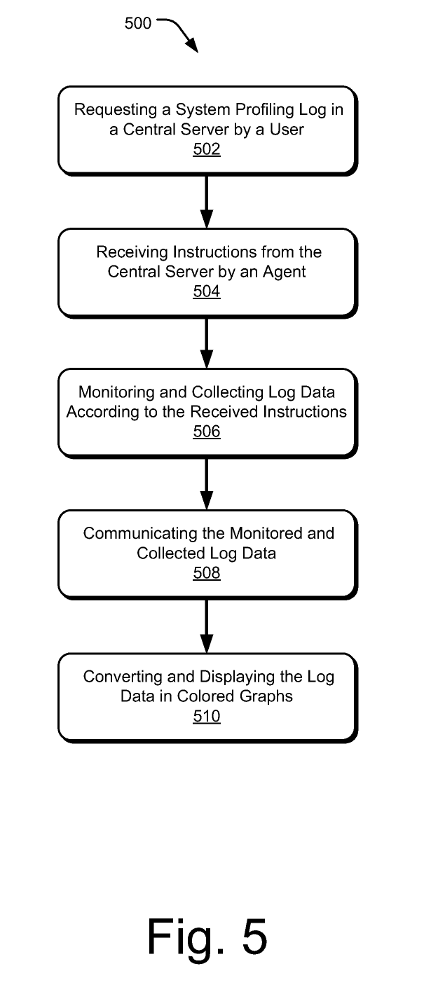

FIG. 5 is a flow chart diagram 500 for an exemplary process of performing system profiling log in a distributed system environment 100. The order in which the method is described is not intended to be construed as a limitation, and any number of the described method blocks can be combined in any order to implement the method, or alternate method. Additionally, individual blocks can be deleted from the method without departing from the spirit and scope of the subject matter described herein. Furthermore, the method can be implemented in any suitable hardware, software, firmware, or a combination thereof, without departing from the scope of the invention.

At block 502, requesting a system profiling log is performed. In an implementation, the system profiling log is requested and activated by a user at a central server (e.g., central server 102). The system profiling log may include LOAD DATA activity for at least a portion of computers (e.g., computers 104) in the distributed system environment 100.

At block 504, receiving instructions by an agent is performed. In an implementation, the agent (e.g., agent 204) is configured to support the system profiling log. For example, a computer 104 may include one or more agents 204 to receive and implement the instructions, such as, monitoring and collecting log data in the computer 104. In other implementations, the instructions include setting up the testing environment for the system profiling log.

At block 506, monitoring and collecting the log data by the agent according to the received instructions is performed. In an implementation, the agent 204 monitors and collects the log data from different processes (e.g., process 300, 302), components (e.g., components 304, 306), and activities (e.g., activity 310, 312, 314, 316, etc.). The process 300, process 302, etc. may include number of processors that are contained in the computer 104. The components 304, 306, etc. may include software applications that are executed in the process 300, 302, etc. The activities 310, 312, 314, 316, etc. can be data access or tasks that are executed to implement the components 304, 306, etc. In other implementations, the activities 310, 312, 314, 316, etc. illustrates a turnaround time for each task during the execution of the software applications (e.g., components 304, 306, etc.). In another implementation, the collecting of the log data includes real-time analysis of the log data at a particular node in the distributed system environment 100.

At block 508, communicating the log data to the central server is performed. In an implementation, the log data, which includes the activities 310, 312, 314, 316, etc., is sent to the central server 102. The central server 102 may integrate the log data and analyze the log data according to the request made by the user.

At block 510, converting and displaying the log data in colored graphical representations is performed. In an implementation, the different activities 310, 312, 314, 316, etc. are integrated by the central server 102 and converted into colored graphs. The activities 310, 312, etc. may be executed on each of the components 304, 306, etc. and the activities 310, 312, etc. are illustrated in different colors over a time period (e.g., timeline in milliseconds as shown in FIG. 4). The colored graphs may further represent real-time analysis of the log data or analysis of the log data that has been previously stored in the computers 104.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims. For example, the systems described could be configured as networked communication devices, computing devices, and other electronic devices.

What is claimed is:

1. A method for system profiling log implemented in a computing device by a processor configured to execute instructions that, when executed by the processor, direct the computing device to perform acts comprising:
requesting the system profiling log in a central server by a user;
receiving instructions from the central server by at least one agent, wherein the at least one agent is located in one or more computing devices;
monitoring and collecting log data by the at least one agent, wherein the log data includes one or more activities that are executed to implement a software application in the one or more computing devices;
communicating the log data to the central server by the at least one agent; and
integrating and converting the log data into colored graphical representations by the central server, wherein the colored graphical representations include timeline for the one or more activities that are executed in the one or more computing devices.

2. The method of claim 1, wherein the system profiling log is used in a distributed system environment.

3. The method of claim 1, wherein the receiving instructions include setting up a testing environment for the system profiling log.

4. The method of claim 3, wherein the testing environment coordinates functions of the one or more computing devices with regard to execution of the system profiling log.

5. The method of claim 1, wherein the wherein the monitoring and the collecting of the log data is implemented according to the instructions received by the at least one agent.

6. The method of claim 1, wherein the communicating the log data to the central server includes sending of real-time log data and the log data that has been previously stored.

7. The method of claim 1, wherein the integrating of the log data includes correlating the one or more activities that are executed in the one or more computing devices.

8. The method of claim 1, wherein the converting the log data into colored graphical representations includes a particular color for a particular activity.

9. The method of claim 8, wherein the colored graphical representations provide locations of a bottleneck in the one or more activities.

10. The method of claim 1, wherein the colored graphical representations provide details of the one or more activity using zoom-in or zoom-out feature of a user interface.

11. A computer-readable storage media having computer-readable instructions thereon which, when executed by a computer, implement a method comprising:
requesting a system profiling log in a central server by a user;
monitoring and collecting log data for the system profiling log, wherein the log data includes one or more activities that are executed to implement a software application in one or more computing devices;
communicating the log data to the central server; and
integrating and converting the log data into colored graphical representations by the central server, wherein the colored graphical representations include timeline for the one or more activities that are executed to implement the software application.

12. The computer-readable storage media of claim 11, wherein the system profiling log is used to gauge performance of parallel programs in a distributed system environment.

13. The computer-readable storage media of claim 11, wherein the monitoring and the collecting of the log data includes real-time analysis of the log data at a particular node in a distributed system environment.

14. The computer-readable storage media of claim 11, wherein the integrating and the converting of the log data includes analysis of at least a portion of the one or more activities in the one or more computing devices.

15. The computer-readable storage media of claim 11, wherein the colored graphical representations provide easy viewing of a system behavior to the user.

16. The computer-readable storage media of claim 15, wherein the system behavior includes correlation of the one or more activities in a distributed system environment.

17. A distributed system environment comprising:
a central server component that initiates a system profiling log, wherein the system profiling log integrates and converts log data into colored graphical representations; and
one or more computing devices that monitor and collect the log data, the log data includes one or more activities in one or more software applications, wherein the log data is communicated by the one or more computing devices to the central server component.

18. The distributed system environment of claim 17, wherein the central server component provides details of the log data to a user by zooming in or zooming out on a particular colored graph.

19. The distributed system environment of claim 17, wherein the log data includes the one or more activities in a parallel program that is executed in the one or more computing devices.

20. The distributed system environment of claim 17, wherein the system profiling log include data load queries on the one or more computing devices.
